(19) United States
(12) Patent Application Publication
(10) Pub. No.: US 2026/0230525 A1
(43) Pub. Date: Aug. 6, 2026

(54) IP ALIAS SUPPORT FOR AN INTERFACE AND IP FOR MULTIPLE PSEUDO DEVICES BACKED BY A SINGLE ROCEV2 CAPABLE PORT

(71) Applicant: International Business Machines Corporation, Armonk, NY (US)

(72) Inventor: Hari Krishna MANCHINENI, Hyderabad (IN)

(21) Appl. No.: 19/046,200

(22) Filed: Feb. 5, 2025

(51) Int. Cl. H04L 67/1097; H04L 61/50

(52) U.S. Cl. CPC H04L 67/1097; H04L 61/50

(57) ABSTRACT

An operating system (OS) is described that enables a Remote Direct Memory Access (RDMA) protocol kernel extension for a network protocol version which does not support multiple interfaces and IP aliasing for RoCEv2. When receiving a request to open a port, a network stack in the OS can transmit a callback (which includes an IP address) to the RDMA protocol kernel extension executing in the OS. The RDMA protocol kernel extension checks if the port is RoCE capable and then can transmit the IP address to the hardware port, which stores the IP address in a Global Identifier (GID) table. The hardware port can then return the index where the IP address is stored in HW GID table to the RDMA protocol kernel extension. This index can then be used to insert the IP address into packets transmitted from the hardware port.

### BACKGROUND

The present invention relates to configuring a hardware port to support multiple interfaces and IP aliasing.

Remote Direct Memory Access (RDMA) over Converged Ethernet (RoCE) is a network protocol that allows RDMA over an Ethernet network. There are multiple RoCE versions. RoCE version 1 (v1) is an Ethernet link layer protocol and as such allows communication between any two hosts in the same Ethernet broadcast domain. RoCE version 2 (v2) is an internet layer protocol which means that RoCEv2 packets can be routed through different subnets. RoCEv2 is also called IP Routable RoCE.

### SUMMARY

According to one embodiment of the present invention, a method includes receiving, at a network stack in an operating system (OS), a request to open a hardware (HW) port; transmitting a callback function to a Remote Direct Memory Access (RDMA) protocol kernel extension (KE) executing in the OS where the callback function comprises an IP address; transmitting the IP address to the HW port from the RDMA protocol KE; storing the IP address in an entry of a Global Identifier (GID) table in the HW port; and returning an index of the entry to the RDMA protocol KE.

According to one embodiment of the present invention, a system that includes one or more processors and memory storing one or more applications which, when executed by the one or more processors, perform operations. The operations include receiving, at a network stack in an operating system (OS), a request to open a hardware (HW) port, transmitting a callback function to a Remote Direct Memory Access (RDMA) protocol kernel extension (KE) executing in the OS where the callback function comprises an IP address, transmitting the IP address to the HW port from the RDMA protocol KE, storing the IP address in an entry of a Global Identifier (GID) table in the HW port, and returning an index of the entry to the RDMA protocol KE.

According to one embodiment of the present invention, one or more computer-readable storage media and program instructions stored on the one or more computer-readable storage media to perform operations. The operations include receiving, at a network stack in an operating system (OS), a request to open a hardware (HW) port; transmitting a callback function to a Remote Direct Memory Access (RDMA) protocol kernel extension (KE) executing in the OS where the callback function comprises an IP address; transmitting the IP address to the HW port from the RDMA protocol KE; storing the IP address in an entry of a Global Identifier (GID) table in the HW port; and returning an index of the entry to the RDMA protocol KE.

### BRIEF DESCRIPTION OF THE DRAWINGS

FIG. 1 illustrates a computing environment, according to one embodiment described herein.

FIG. 2 is a flowchart for configuring a hardware port to support multiple interfaces and IP aliasing, according to one embodiment described herein.

FIG. 3 illustrates configuring a RoCE port, according to one embodiment described herein.

FIG. 4 is a flowchart performed by network stack for reconfiguring a RoCE port, according to one embodiment described herein.

FIG. 5 is a flowchart performed by RDMA stack after callback from network stack for reconfiguring a RoCE port, according to one embodiment described herein.

### DETAILED DESCRIPTION

The embodiments herein describe techniques for enabling an operating system (OS) that has a RDMA protocol kernel extension (KE) for a network protocol version which does not support virtual ports to still be able to support multiple interfaces and IP aliasing using a single hardware port. For example, an OS may have an Open Fabrics Enterprise Distribution (OFED) which is open-source software stack that provides support for high-performance interconnects in data centers, specifically targeting RDMA (Remote Direct Memory Access) and high-bandwidth, low-latency communication technologies. Some versions of OFED may only support RoCEv1 and not RoCEv2. RoCEv1 packets like RoCEv2 cannot cross a subnet. Patching a OFED that only supports RoCEv1 uses special methods to make it compatible with RoCEv2 especially in case of IP alias support for an Interface and IP for multiple pseudo devices backed by a single RoCE port. However, with the embodiments herein, an OS with an OFED design (e.g., an OFED KE) that only supports RoCEv1 can be used to set up multiple interfaces (and IP aliasing) on a hardware port that is RoCE capable to support RoCEv2. For example, a new verb (and technique) can be used that enables an OFED KE that only supports RoCEv1 until now to nonetheless support RoCEv2 on a RoCE capable port. While the present disclosure is discussed in the context of RoCE and OFED, the embodiments herein can be generally applied where an OS does not have software (e.g., a KE) that supports establishing multiple interfaces on a single port (e.g., a virtual port).

Rather than a bottom up approach of RoCEv1 (where a call is made from the hardware device driver to the OFED KE when a port is opened), the embodiments herein describe a top down approach. When an OFED KE is loaded into the OS, the OFED KE registers with the network stack (e.g., TCPIP stack) to generate a callback when an interface/IP was configured or removed. When an user sends a request to open a port or configure an IP (e.g., ifconfig) in the OS, the network stack provides a callback to the registered OFED KE. In turn, the OFED KE calls an un-exported new verb to the hardware driver to store/insert the IP address for that port in a Global Identifier (GID) table. Each IP configured on a particular RoCE port will have separate GID table entries in that hardware port. Once un-exported new verb returns, the OFED KE will know the index at which this IP is stored/inserted in the GID table. This index can then be used for various purposes one being, to establish a context for queue pairs (QP) which use the index in the GID table as an offset so the IP address stored in the table can be used as source IP address while transmitting RoCEv2 packets. In this manner, the patched RoCEv1 OFED can support multiple interfaces and IP aliasing for RoCEv2 on a RoCE physical port.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as RDMA protocol kernel extension (KE) 200, which is in the OS 122. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

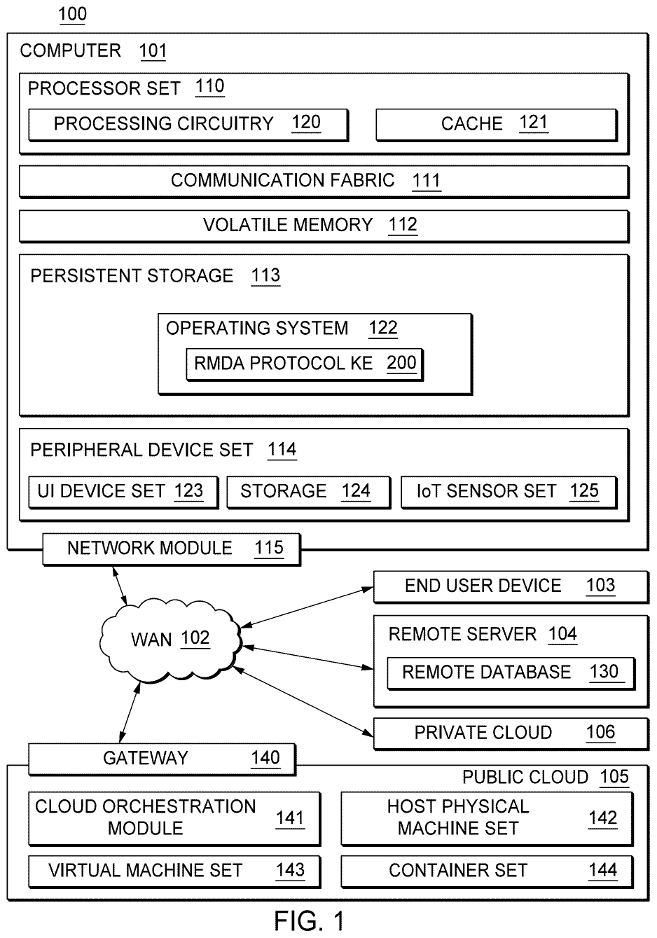

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

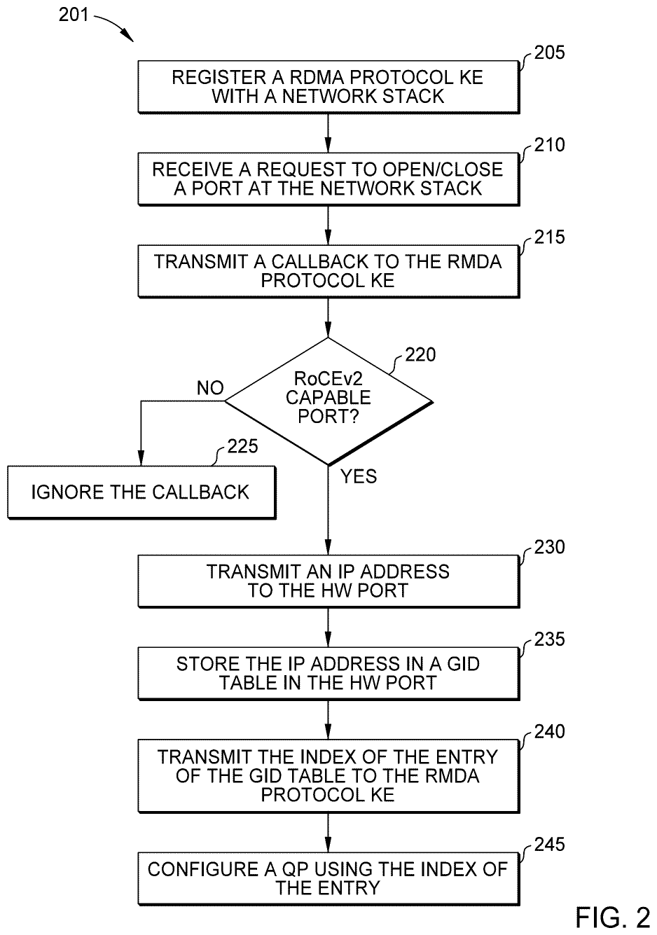

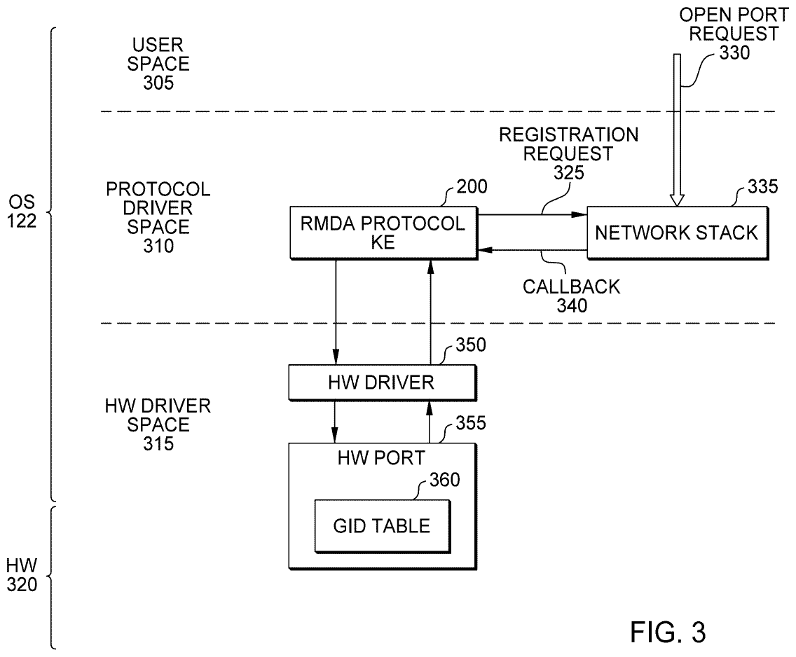

FIG. 2 is a flowchart of a method 201 for configuring a hardware port to support multiple interfaces and IP aliasing, according to one embodiment described herein. For ease of explanation, the method 201 is discussed in tandem with FIG. 3 which illustrates configuring a virtual port, according to one embodiment described herein.

At block 205, the OS registers a RDMA protocol KE (e.g., the protocol KE 200, such as an OFED KE) with a network stack for each port open/close with IP addition/removal. As shown in FIG. 3, the OS 122 includes a user space 305, protocol driver space 310, and hardware (HW) driver space 315. In this example, the RDMA protocol KE 200 is in the protocol driver space 310, along with a network stack 335 (e.g., a TCP/IP stack). The network stack 335 is the set of protocols that govern how data is transmitted over the internet, while the RDMA protocol KE 200 can be the set of protocols that govern how data is transmitted using a specific network protocol, such as RDMA, RoCE, InfiniBand®, or others.

When the OS loads the RDMA protocol KE 200 (e.g., an OFED KE) into the protocol driver space 310, the RDMA protocol KE 200 can send a registration request 325 to the network stack 335. The registration request 325 registers a callback function with the network stack 335 that can be used when the network stack 335 receives a request to open a port, as discussed next.

At block 210, the network stack receives a request to open (or close) a hardware port. As shown in FIG. 3, the user space 305 (e.g., in response to a user application) transmits an open port request 330 to the network stack 335. At this point, the network stack 335 may not know if the request 330 is to open a RoCE port or NIC only port

At block 215, the network stack transmits a callback 340 (e.g., the callback function that was registered in response to the registration request 325) to the RDMA protocol KE 200. The callback 340 can include a structure (similar to ifaddr) that has information such as an IP address, interface information (pointer to struct ifnet), etc. with which the RDMA protocol KE 200 internal structures can be created for successful operation. In one embodiment, a low level design for such implementation can be provided by Berkeley Software Design (BSD) which most Unix® OS uses; however similar designs can be used for other types of OS.

At block 220, the RDMA protocol KE 200 determines whether the request is to open a interface backed by a RoCE port or a pseudo device like virtual local area network (VLAN) that is backed by a RoCE physical port If the interface is not backed by the RoCE capable port, the callback from the network stack is ignored by the RDMA protocol stack at block 225 else, the method 201 proceeds to block 230.

However, if the RDMA protocol KE 200 determines that the interface backed port is RoCE capable, the method 201 proceeds to block 230 where the RDMA protocol KE 200 transmits an IP address to the HW port 355. This IP address can be the same one that was provided to the RDMA protocol KE 200 by the callback 340.

At block 235, the HW port 355 stores the IP address in a GID table 360. In one embodiment, to provide the IP address to the HW port 355, the RDMA protocol KE 200 can use a new un-exported verb (e.g., a new verb in OFED) which updates (adds, in this case) the IP address to the GID table 360 in the HW port 355. In one embodiment, the new verb can also update a GID cache in the HW driver 350 to add the IP address.

In one embodiment, the new verb is passed a command (which can be OR'd in a tbl_index argument in the case of RoCE) to add GID information (which can include the IP address among other information) in the GID cache in the HW driver 350 and the GID table 360 in the HW port 355. However, in one embodiment, the OS does not permit this verb from being exported from the RDMA protocol KE 200 so that a user cannot write directly into the HW GID table 360 to avoid security issues.

At block 240, the HW port 355 transmits the index of the entry of the GID table 360 that stores the IP address to the RDMA protocol KE 200. The HW port 355, via the same new un-exported verb (when it returns) will inform the RDMA protocol KE 200 where it stored the IP address in its GID table (i.e., the index in the GID table). In one embodiment, the RDMA protocol KE 200 can use a global linked list to store the indexes of the IP addresses it has sent to the HW ports in the computing system.

At block 245, the RDMA protocol KE 200 configures a QP using the index for the entry in the GID table storing the IP address. In one embodiment, the index can be used as an offset that is stored in a QP context for a QP. The QP can then use the index while transmitting packets from the HW port 355. For example, with RoCEv1, the level 3 (L3) header (i.e., the network level in the open system interconnection (OSI) model) is in a format for routing on an InfiniBand network (e.g., hence RoCEv1 packets are restricted to a single subnet). However, with RoCEv2, the L3 header in a packet includes an IP address that can route the packet between subnets (e.g., in the internet). The QP with RoCEv2 can use the index to instruct the HW port 355 which IP address to place in the L3 headers of the packets the QP sends on the network. In this manner, the method 201 enables, during operation, a single HW port 355 to support different interfaces.

Moreover, when the RDMA protocol KE 200 is loaded into the OS 122, multiple interfaces may have already been configured. As such, in one embodiment, the RDMA protocol KE 200 scans list of configured interfaces on the system that are backed by RoCE capable physical ports and performs the processing discussed in method 201 to register with itself (RDMA protocol KE). Thus, the embodiments herein can be used to open new ports as well as reconfigure already open ports to register with RDMA protocol KE to support RoCEv2 functionality.

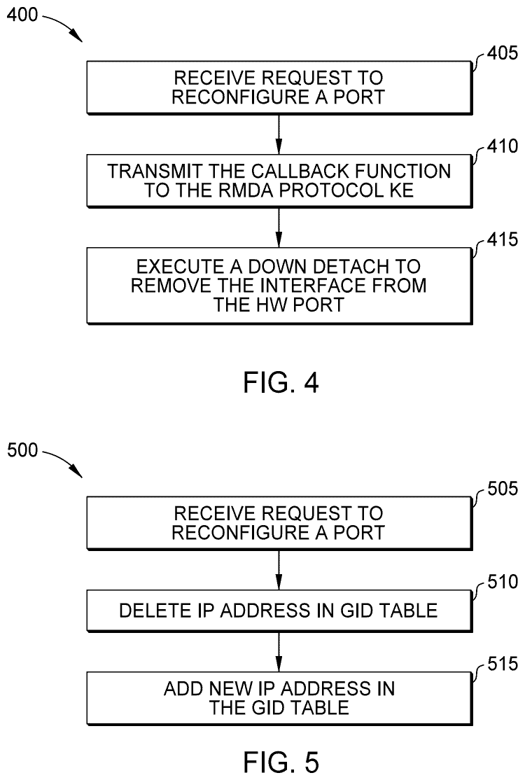

While FIGS. 2 and 3 describe opening a new port, FIGS. 4 and 5 discuss different techniques for reconfiguring an already opened port.

FIG. 4 is a flowchart of a method 400 performed by network stack for reconfiguring a RoCE port, according to one embodiment described herein. At block 405, the network stack receives a request to reconfigure a port. In this case, it is assumed the HW port has already been configured as discussed in FIG. 2.

At block 410, the network stack can then send a callback function to the RDMA protocol KE. The callback function can include a new IP address for the interface.

In response, the RDMA protocol KE can perform blocks 220 and 230 in FIG. 2 to store the new IP address in the GID table of the HW port and receive the corresponding location of the index in the table where the IP address is stored. That is, at least a portion of the method 201 can be used to reconfigure the HW port.

At block 415, when the user wants to remove an interface (ifconfig en1 down detach), the network stack (PRC_IFDETACH) provides a callback to RDMA protocol KE which in turn executes the same new un-exported verb with the index and command to remove entry in HW GID table. One example of a down detach command is: ifconfig en1 down detach (PRC_IFDETACH). This command can then invalidate the entry in the HW GID table for the interface en1. That is, the IP address stored at that location is no longer valid.

In another embodiment, the method 500 in FIG. 5 can be used to reconfigure a RoCE port. That is, FIG. 5 is a flowchart performed by RDMA stack after callback from network stack for reconfiguring a RoCE port. In this example, rather than detaching the port, the new verb can be used to reconfigure the port.

At block 505, the network stack receives a request to reconfigure a port. In this case, it is assumed the HW port has already been configured as discussed in FIG. 2.

At block 510, the RDMA protocol KE deletes an IP address in the GID table. For example, the RDMA protocol KE can use the new verb to delete the IP address rather than add the IP address as was done in FIG. 2. When adding the IP address, the new verb instructs the HW port to return the index of the entry that stores the IP address, but when deleting an IP address, the new verb can include the GID index of the already allocated IP address that should be deleted. That is, the GID index of the entry storing the IP address to be deleted can be an argument in the verb.

As an example, SIOCAIFADDR/SIOCDIFADDR commands can be issued from the ifconfig command. When an interface (e.g., en4) is already configured with an IPv4 address (e.g., 192.168.15.15) and is up and running, the IPv4 address can be changed using “ifconfig en4 192.168.15.150 up” dynamically which in turn executes multiple ioctl calls, out of which the SIOCAIFADDR/SIOCDIFADDR commands can be issued.

At block 515, the protocol adds a new address in the GID table. Here, the new verb can be used to add a new address to the GID table, as discussed in the method 201 in FIG. 2.

While the foregoing is directed to embodiments of the present invention, other and further embodiments of the invention may be devised without departing from the basic scope thereof, and the scope thereof is determined by the claims that follow.

What is claimed is:

1. A method comprising:
receiving, at a network stack in an operating system (OS), a request to open a hardware (HW) port;
transmitting a callback function to a Remote Direct Memory Access (RDMA) protocol kernel extension (KE) executing in the OS, wherein the callback function comprises an IP address;
transmitting the IP address to the HW port from the RDMA protocol KE;
storing the IP address in an entry of a Global Identifier (GID) table in the HW port; and
returning an index of the entry to the RDMA protocol KE.

2. The method of claim 1, wherein the RDMA protocol KE is an Open Fabrics Enterprise Distribution (OFED) KE.

3. The method of claim 2, wherein the HW port is a remote direct memory access (RDMA) over Converged Ethernet (RoCE) capable port.

4. The method of claim 3, wherein a design of the OFED KE does not support RoCEv2.

5. The method of claim 1, further comprising, before transmitting the callback function:
loading the RDMA protocol KE into the OS; and
responsive to loading the RDMA protocol KE, registering the RDMA protocol KE with the network stack to generate the callback used when interfaces are being configured/unconfigured or when new IP addresses are being configured in the OS.

6. The method of claim 1, further comprising:
determining, in response to receiving the callback at the RDMA protocol KE, that the hardware port is a RoCE port, wherein the IP address is transmitted to the HW port responsive to this determination.

7. The method of claim 1, further comprising:
configuring a queue pair (QP) to communicate to a network via the HW port using the index of the entry of the GID table.

8. A system, comprising:
one or more processors;
memory storing one or more applications which, when executed by the one or more processors, perform operations comprising:
receiving, at a network stack in an operating system (OS), a request to open a hardware (HW) port;
transmitting a callback function to a Remote Direct Memory Access (RDMA) protocol kernel extension (KE) executing in the OS, wherein the callback function comprises an IP address;
transmitting the IP address to the HW port from the RDMA protocol KE;
storing the IP address in an entry of a Global Identifier (GID) table in the HW port; and
returning an index of the entry to the RDMA protocol KE.

9. The system of claim 8, wherein the RDMA protocol KE is an Open Fabrics Enterprise Distribution (OFED) KE.

10. The system of claim 9, wherein the HW port is a remote direct memory access (RDMA) over Converged Ethernet (RoCE) capable port.

11. The system of claim 10, wherein a design of the OFED KE does not support RoCEv2.

12. The system of claim 8, wherein the operations further comprising, before transmitting the callback function:
loading the RDMA protocol KE into the OS; and
responsive to loading the RDMA protocol KE, registering the RDMA protocol KE with the network stack to generate the callback function.

13. The system of claim 8, wherein the operations further comprising:
determining, in response to receiving the callback function at the RDMA protocol KE, that the hardware port is a virtual port that can support multiple interfaces, wherein the IP address is transmitted to the HW port responsive to this determination.

14. The system of claim 8, wherein the operations further comprising:
configuring a queue pair (QP) to communicate to a network via the HW port using the index of the entry of the GID table.

15. A computer program product comprising:
one or more computer-readable storage media; and
program instructions stored on the one or more computer-readable storage media to perform operations comprising:
receiving, at a network stack in an operating system (OS), a request to open a hardware (HW) port;
transmitting a callback function to a Remote Direct Memory Access (RDMA) protocol kernel extension (KE) executing in the OS, wherein the callback function comprises an IP address;
transmitting the IP address to the HW port from the RDMA protocol KE;
storing the IP address in an entry of a Global Identifier (GID) table in the HW port; and
returning an index of the entry to the RDMA protocol KE.

16. The computer program product of claim 15, wherein the RDMA protocol KE is an Open Fabrics Enterprise Distribution (OFED) KE, wherein the HW port is a remote direct memory access (RDMA) over Converged Ethernet (RoCE) capable port.

17. The computer program product of claim 16, wherein a design of the OFED KE does not support RoCEv2.

18. The computer program product of claim 15, wherein the operations further comprising, before transmitting the callback function:
loading the RDMA protocol KE into the OS; and
responsive to loading the RDMA protocol KE, registering the RDMA protocol KE with the network stack to generate the callback function.

19. The computer program product of claim 15, wherein the operations further comprising:
determining, in response to receiving the callback function at the RDMA protocol KE, that the hardware port is a RoCE port, wherein the IP address is transmitted to the HW port responsive to this determination.

20. The computer program product of claim 15, wherein the operations further comprising:
configuring a queue pair (QP) to communicate to a network via the HW port using the index of the entry of the GID table.
